(19) United States
(12) Patent Application Publication
(10) Pub. No.: US 2023/0043732 A1
(43) Pub. Date: Feb. 9, 2023

(54) CONNECTING DEVICE FOR AN ADJUSTABLE BLADE OF A GAS TURBINE AND GAS TURBINE

(71) Applicant: MTU Aero Engines AG, München (DE)

(72) Inventors: Axel Stettner, Dachau (DE); Christian Roth, Munich (DE); Werner Humhauser, Moosburg (DE)

(73) Assignee: MTU Aero Engines AG, München (DE)

(21) Appl. No.: 17/817,177

(22) Filed: Aug. 3, 2022

(30) Foreign Application Priority Data
Aug. 5, 2021 (DE) 10 2021 120 382.1

(51) Int. Cl. F01D 25/28; F04D 29/56

(52) U.S. Cl. CPC F01D 25/28; F04D 29/563; F05D 2260/37

(57) ABSTRACT

The invention relates to a connecting device for an adjustable blade or vane of a gas turbine, comprising a journal element connected to a respective blade or vane and a lever element connected to the journal element, wherein the lever element and the journal element are jointly movable about a journal axis of rotation. A clamping element is provided, being situated between the lever element and the journal element, such that a force-locking connection is or can be produced between the journal element, the clamping element, and the lever element. The lever element, the clamping element, and the journal element are aligned relative to each other by means of a positioning element, the positioning element being received in a first seat of the journal element and a corresponding second seat of the lever element.

### BACKGROUND OF THE INVENTION

The invention relates to a connecting device for an adjustable blade or vane of a gas turbine, especially an aircraft gas turbine, and a gas turbine, especially an aircraft gas turbine, having a connecting device.

Gas turbines have guide vanes and rotating blades. These are arranged on respective guide vane rings or respective rotating blade rings. It is customary to mount the blades and vanes in the ring such that the individual blades or vanes can be rotated about their longitudinal axis. This is especially common with guide vanes, in order to make possible an optimal guidance of the flow onto the rotating blades. For this purpose, lever elements are arranged at end journals of the respective vanes, with which the orientation of the individual vanes can be adjusted. For the mechanical connection of the individual vanes to the corresponding lever element, the end journal has a threaded section or some other shape enabling the transmission of force from the lever element to the vane. In the case of smaller vanes, it is no longer possible below a certain size to connect the individual vanes in this manner to the lever element on the journal element. For this reason, special connecting devices are used for smaller vanes, making possible a connection of a vane to a lever element.

One such connecting device for an adjustable blade or vane of a gas turbine is disclosed for example in EP 3 524 781 B1. The connecting device described there comprises a journal element connected to a corresponding blade or vane and a lever element connected to the journal element, the lever element and the journal element being mounted to be mutually movable axially about a journal axis of rotation. It is proposed to arrange a clamping element between the lever element and the journal element, being mounted such that a force-locking connection is produced between the journal element, the clamping element, and the lever element. In this case, the lever element, the clamping element, and the journal element are aligned relative to each other by a positioning element, the positioning element being received in a journal recess and a lever recess.

In US 2019/0353197A1, there is disclosed a locking cap to restrict the rotating of a fastening element. The fastening element connects a first component of the gas turbine engine and a second component of the gas turbine engine. An engagement between a locking section and the first component restricts the rotation of the locking section. A wedge extends from a base and can be connected to the fastening element, so that the fastening element cannot rotate relative to the wedge when the locking section has engaged with the first component.

US 2019/0178096 A1 discloses a lever attachment for the rotation-resistant connection of a guide vane to a lever for a guide vane adjustment of a turbomachine. The lever forms a single piece with a radially outer end of a substantially hollow cylindrical clamping sleeve which coaxially surrounds the guide vane shaft in sections.

### SUMMARY OF THE INVENTION

An object of the invention is to provide a connecting device making possible a space-saving connection of a guide vane to a lever element.

This object is achieved by a connecting device for an adjustable vane or blade of a gas turbine and by a gas turbine of the present invention. Advantageous embodiments with expedient modifications of the invention are discussed in detail below.

A first aspect of the invention relates to a connecting device for an adjustable vane or blade of a gas turbine. The gas turbine may be in particular an aircraft gas turbine. The connecting device comprises a journal element connected to a respective blade or vane. The connecting device comprises a lever element connected to the journal element, wherein the lever element and the journal element are jointly movable about a journal axis of rotation. In other words, the journal element is connected to the lever element, so that a rotation of the journal element and the lever element about a journal axis of rotation of the journal element can occur. A clamping element is provided for the connecting device, being situated between the lever element and the journal element in such a way that a force-locking connection is or can be produced between the journal element, the clamping element and the lever element. In other words, the connecting device comprises the clamping element, which is arranged between the journal element and the lever element to provide a force-locking connection. The lever element, the clamping element and the journal element are oriented relative to each other by a positioning element. In other words, the connecting device comprises the positioning element, which is designed to orient the lever element, the clamping element and the journal element relative to each other. The orienting or alignment can refer to a direction with respect to the journal axis of rotation. The positioning element is received in a first seat of the journal element and a corresponding second seat of the lever element. In other words, the journal element comprises the first seat and the lever element comprises the second seat. The first and the second seats are each designed to receive the positioning element so as to align the lever element and the journal element relative to each other by the positioning element.

It is provided that the first seat of the journal element has a depth which is less than the journal radius of the journal element. In other words, the first seat protrudes into the journal element with this depth. However, the depth is less than the radius which the journal element has. In this way, the depth of the first seat does not protrude into the center of the journal. The depth describes the radial component of the dimensions of the first seat. The second seat of the lever element is configured as a groove running axially to the journal longitudinal axis, extending along a radially inner contact surface of a sleeve-like coupling section of the lever element. In other words, the second seat which is provided by the lever element is a groove. The groove extends along the axial direction or also the longitudinal direction of the journal axis of rotation. The second seat is situated along the inner radial contact surface of the sleeve-like coupling section of the lever element. The sleeve-like coupling section can be, for example, a hollow cylinder or a hollow cone, the inner contact surface being the inner surface of the hollow cylinder or the hollow cone. By providing the second seat as a groove, it is possible to first arrange the positioning element, which can also be called a feather key, in the first seat of the journal element and then introduce it into the second seat. The positioning element can protrude from the first seat when it has been inserted in it. A protruding portion of the positioning element can be led along the groove when the lever element is placed on the journal element. The groove can have a depth which prevents the positioning element from falling out. In this way, it is possible to move the sleeve-like coupling element across the journal element in the axial direction of the journal element, the positioning element being led along the groove to an end section of the second seat.

The invention affords the advantage that a space-saving possibility is created for fastening a journal element on the lever element by the positioning element.

An enhancement of the invention provides that the coupling section and the journal element are arranged concentrically to each other. In other words, it is proposed that the coupling section is arranged around the journal element, the journal element being situated at the center, and an edge section being formed by the coupling section.

An enhancement of the invention provides that the clamping element comprises a threaded section, on which a nut is or can be fastened, the threaded section being arranged on an axial section of the clamping element facing away from the journal element. In other words, the clamping element has a thread, which is designed to make possible an arrangement of the nut on the clamping element. The thread is situated in the threaded section of the clamping element. The threaded section is located in an axial region in relation to the longitudinal axis, which faces away axially from the journal element. A bore of the threaded section comprises a driving profile. The driving profile is provided to make possible the firm holding of the clamping element by a tool having a shape corresponding to the driving profile during the mounting of the nut. In this way, it is possible to hold the clamping element so that a rotating of the clamping element or a resulting force acting in the tangential direction in relation to the journal axis can be prevented during the screwing of the nut onto the thread. This affords the advantage that forces acting tangentially on the positioning element during the mounting of the nut can be reduced.

An enhancement of the invention provides that the driving profile is configured as an inner toothing. In other words, the driving profile has inwardly directed teeth.

An enhancement of the invention provides that the driving profile is configured as a polygon profile. In other words, the driving profile has multiple edges, making it possible to hold onto the clamping element. The polygon profile can be a hexagon or square profile, for example.

An enhancement of the invention provides that the journal element comprises multiple first seats, and the lever element comprises multiple second seats in which respective positioning elements are situated. In other words, the connecting device comprises multiple positioning elements for aligning the lever element to the journal element. The individual positioning elements are situated in one of the first seats of the journal element and one of the second seats of the lever element. This enhancement affords the advantage that the journal element and the lever element are joined together by multiple positioning elements. This produces the advantage that tangentially acting forces are distributed over multiple positioning elements.

An enhancement of the invention provides that the first seats and the second seats have identical radial angles to each other. In other words, it is provided that the first seats and the corresponding second seats are distributed uniformly in terms of their radial alignment.

An enhancement of the invention provides that the first seats and the second seats make different angles with each other. This modification affords the advantage that a predetermined arrangement of the lever element on the journal element can be established. In this way, a skewing of the journal element in the lever element can be avoided.

An enhancement of the invention provides that the first seat of the journal element is situated at an axial height of the contact surface of the journal element. In other words, the first seat of the journal element is situated, in the axial direction, in the axial region where the contact surface of the journal element is located, which is pressed against the contact surface of the lever element during the installation. This enhancement affords the advantage that no additional axial region need be provided for the placement of the positioning element. Thus, a more space-saving arrangement is possible than is the case with separate axial regions.

An enhancement of the invention provides that the lever element has an opening which runs from the groove to an outer wall of the lever element. In other words, an outwardly aligned surface of the groove, against which the positioning element can abut in the installed state, is connected by an opening, such as a bore, to an outer wall of the lever element. This enhancement affords the advantage that the presence of a positioning element in the second seat in the assembled state of the connecting device can be verified. This can be done, for example, by simply looking at it or by using an associated tool, such as a plug gage. In this way, one can check to see if the positioning element was forgotten during the installation process.

An enhancement of the invention provides that one positioning element cross section of the positioning element has the shape of a trapezium and/or a triangle at least for a region along a longitudinal direction of the positioning element. In other words, the positioning element cross section has the shape of a trapezium or a triangle at least for a region along a longitudinal direction of the positioning element. Accordingly, the first seat and the second seat have a seat shape of corresponding to the triangle or the trapezium.

An enhancement of the invention provides that the positioning element is received by the first seat and the second seat such that the positioning element is situated with a longitudinal direction offset from the center of the journal element. In other words, the positioning element runs with an offset from the center of the cross section of the journal element.

An enhancement of the invention provides that the journal element has a step or profile at one axial end of the journal element, which corresponds to a profile of a bore of the threaded section, in order to establish a definite alignment of the journal element in the clamping element. For example, steps or lugs can be arranged on the axial end of the journal element, being aligned axially or radially, in order to make possible a distinct arrangement in the bore of the threaded section.

A second aspect of the invention relates to a gas turbine, especially an aircraft gas turbine, comprising a connecting device.

The features and the advantages presented in regard to the connecting device according to the first aspect of the invention hold accordingly for the gas turbine according to the second aspect of the invention, and vice versa.

### BRIEF DESCRIPTION OF THE DRAWING FIGURES

Further features of the invention will emerge from the claims and the exemplary embodiments. The features and combinations of features mentioned above in the specification and also the features and combinations of features mentioned below in the description of the figures and/or shown only in the figures can be used not only in the particular indicated combination, but also in other combinations or standing alone, without leaving the scope of the invention. Thus, embodiments not explicitly shown or discussed in the figures, yet which emerge from and can be created from the explained embodiments by separate combinations of features should be seen as also being encompassed and disclosed by the invention. Embodiments and combinations of features which thus do not have all the features of an originally formulated independent claim should also be considered to be disclosed. Herein:

FIG. 1 shows a schematic representation of a connecting device according to the invention for an adjustable blade or vane of a gas turbine;

FIG. 2 shows a schematic representation of a cross section through the connecting device according to the invention as shown in FIG. 1;

FIG. 3 a schematic representation of another embodiment of the journal element in concentric arrangement in another embodiment of the lever element; and

FIG. 4 a schematic representation of the other embodiment of the journal element of FIG. 3.

### DESCRIPTION OF THE INVENTION

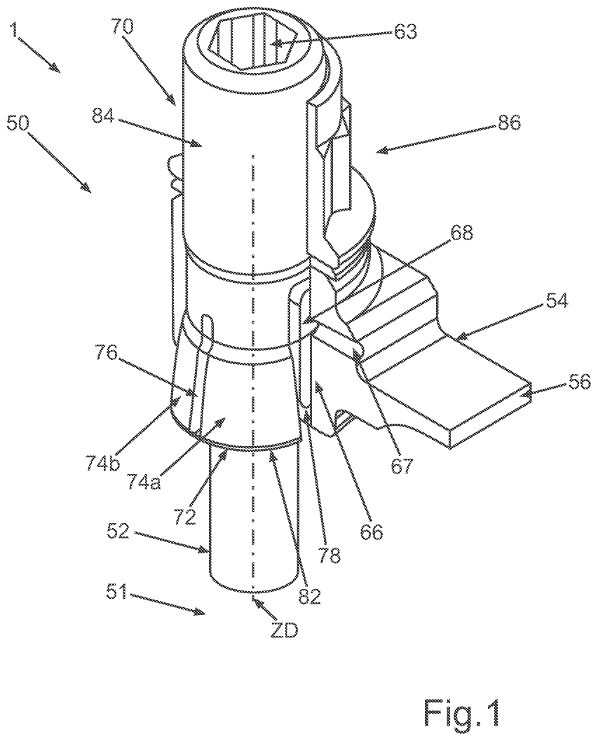

FIG. 1 shows a schematic representation of a connecting device 50 for an adjustable blade or vane 51 of a gas turbine 10. One can see a journal element 52, which may be joined as a single piece to the associated blade or vane 51. The blade or vane 51 can be, for example, a rotating blade or a guide vane. The connecting device 50 comprises a lever element 54. The lever element 54 is adapted to rotate the journal element 52 about the axial axis AR of the journal element 52 and thereby change the alignment of the blade or vane 51 in the gas turbine 10. In order to make possible a transmission of force exerted by the lever element 54 on the journal element 52, the lever element 54 can be connected via a clamping element 70 to the journal element 52. In order to produce the connection, the journal element 52 is arranged in the clamping element 70 by its side 58 facing away from the blade or vane 51. The clamping element 70 is arranged in one region in a coupling section 62 of the lever element 54. In order to align the lever element 54 and the journal element 52 relative to each other with respect to a circumferential direction of the connecting device 50, a positioning element 68 is provided. The positioning element 68 is arranged in a first seat 60 of the journal element 52 and a corresponding second seat 66 of the lever element 54. The first seat 60 can thus be the seat which is provided by the journal element 52 for receiving the positioning element 68 by way of the journal element 52. The first seat 60 can be designed such that the positioning element 68 can lie with a form fit inside the first seat 60 of the journal element 52. The depth of the first seat 60 may be chosen such that the depth is less than the radius of the journal element 52. Thus, the first seat 60 does not protrude into the center of the journal element 52. The corresponding second seat 66 of the lever element 54 can be provided to make possible a receiving of the positioning element 68 by the lever element 54. The second seat 66 can be configured as a groove. The groove can run parallel to the axial axis AR of the journal element 52 and have an open end at an axial end of the lever element 54. In particular, the groove can run along a radially inner contact surface 82 of a sleeve-like coupling section 62 of the lever element 54. The radially inner contact surface 82 of the coupling section 62 of the lever element 54 can be provided to transmit, by exerting a pressure onto a radially outer contact surface 80 of the clamping element 70, a pressure on the journal element 52 and thereby is able to mount the journal element 52 in the clamping element 70. The coupling section 62 may extend in the manner of a sleeve about the radially outer contact surface 80 of the clamping element 70 and the journal element 52. The clamping element 70 can have third recesses 76, which can separate individual clamping sections 74 from each other. In this way, an elastic bending of the individual clamping sections 74 is made possible. The positioning element 68 can protrude through one of these recesses 74. The positioning element 68 can rest against edge walls of one of the recesses 74, so that the clamping element 70 can also be aligned with respect to a circumferential direction about the axial axis AR in relation to the journal element 52 and the lever element 54. In order to maintain a small axial dimension for the connecting device 50, it may be provided that the positioning element 68 and the first seat 60 as well as the second seat 66 are arranged in the coupling section 62. This affords the advantage that it is not necessary to provide an additional axial region for aligning the journal element 52, the clamping element 70 and the lever element 54. It can be provided that multiple positioning elements 68 are provided for the positioning. In this case, the journal element 52 will have multiple first seats 60. The first seats 60 of the journal element 52 can make angles with each other that may be identical or may differ from each other. Differing angles have the advantage that they can be chosen such that only one orientation of the individual components 52, 54, 70 relative to each other is possible. In this way, the components 52, 54, 70 can be prevented from skewing relative to each other. In the event that multiple positioning elements 68 are used, the lever element 54 accordingly has multiple second seats 66, corresponding to the respective first seats 60. In order to make sure that the positioning element 68 has been installed in the connecting device 50 when the connecting device 50 is installed, it can be provided that the lever element 54 has an opening 67 which runs from the second seat 66 to an outer wall of the lever element 54. In this way, it is possible to check, for example by a plug gage, to make sure that the positioning element 68 is situated in the connecting device 50. Thus, one can make sure that the positioning element 68 is installed in the connecting device 50 and that it prevents a rotation of the elements 52, 54, 70 relative to each other during the operation of the connecting device 50. The connecting device 50 may have a threaded section 84, which is located on an axial side of the clamping element 70 opposite the blade or vane 51. A nut 86 can be arranged on the threaded section 84. When the nut 86 is tightened, an axial displacement of the lever element 54 relative to the clamping element 70 occurs. Due to the axial displacement, the radially outer contact surface 80 of the lever element 54 can be pressed against the radially inner contact surface of the clamping element. With such a method, it is possible to transmit the force acting tangentially about the axial axis AR due to the rotary movement of the nut 86 from the lever element 54 to the clamping element 70. This can result in the transmitting of a sideways force on the positioning element 68 in the region of the first seat 60 and the second seat 66. This may lead to a damaging and/or wear of the positioning element 68. In order to avoid such forces, it can be provided that the clamping element 70 has a driving profile 63 at one axial end. The driving profile 63 can have an inner toothing, for example, or it can be configured as a polygon. This affords the advantage that a rotating of the clamping element 70 during the tightening of the nut 86 can be prevented by arranging a suitable counterpiece to the driving profile 63. In this way, a damaging of the positioning element 68 during the tightening can be prevented.

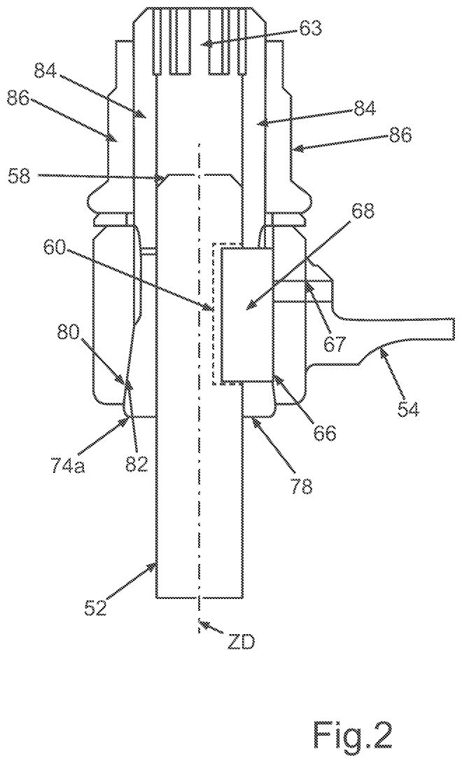

FIG. 2 shows a schematic representation of a cross section through the schematic representation of the connecting device 50 shown in FIG. 1. The connecting device 50 is shown in an installed condition, revealing a position of the positioning element 68 in the first seat 60 of the journal element 52 and the second seat 66 of the lever element 54. The depth of the first seat 60 of the journal element 52 does not reach to the center of the journal element 52. A depth of the second seat is chosen such that the positioning element 68 is prevented from falling out of the first seat in the installed state. One notices the course of the opening 67, which can be configured for example as a duct, which can run from one section of the second seat to an outer surface of the lever element 54. The opening 67, for example being a bore, can be introduced in the lever element 54 such that the presence of the positioning element 68 can be verified with a suitable tool, such as a plug gage. The positioning element 68 can be installed at the radial height of the contact surface 80 in a precision journal seat 60 of limited depth in the journal element 52 and it positions the lever element 54 by the groove as the second seat 66. The second seat 66 has a limited depth, so that the positioning element 68 cannot fall out. With appropriate size of the journal element 52, multiple positioning elements 68 can be used, being distributed uniformly or non-uniformly. A non-uniform distribution, for example, can prevent an incorrect installation. An inner toothing 63 or also a square or hexagon or polygon or toothing can be introduced into the bore of the threaded section 84, by which the clamping element 70 can be held firmly during the installation when tightening the nut 86. In this way, little or no force will be acting on the positioning element 68 during the installation.

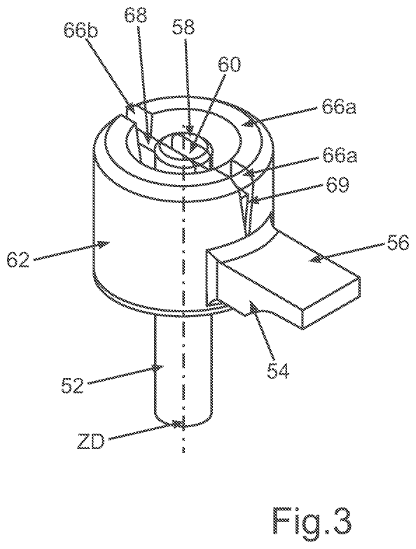

FIG. 3 shows a schematic representation of another embodiment of the journal element 52 in concentric arrangement in another embodiment of the lever element 54. There are shown the first seat 60 of the journal element, the second seat 66 of the lever element, and the positioning element 68 in an embodiment with a trapezoidal cross-sectional profile. A positioning element cross section 69 of the positioning element 68 can have the shape of a trapezium and/or a triangle, at least in regions along the longitudinal direction of the positioning element 68. Corresponding to the shape of the positioning element cross section 69 of the positioning element 68, the first seat 60 and/or the second seat 66 can have a corresponding trapezoidal or triangular shape. This can increase the accuracy of alignment of the lever element 54 to the journal element 52 in comparison to a cuboid shape of the positioning element cross section 69 of the positioning element 68, because a more precise arrangement of the positioning element 68 in the first seat 60 and the second seat 66 is possible. The first seat 60 and the second seat 66 can be produced off center, in order to clearly establish the orientation of blade or vane 51 and connecting device 50. In other words, it can be provided that the first seat 60 and the second seat 66 are positioned such that the positioning element 68 in the assembled state is arranged with its longitudinal direction not running centrally through the center of the journal element 52, but instead set off from it. This affords the advantage that a distinct arrangement of the journal element 52 in relation to the lever element 54 becomes possible.

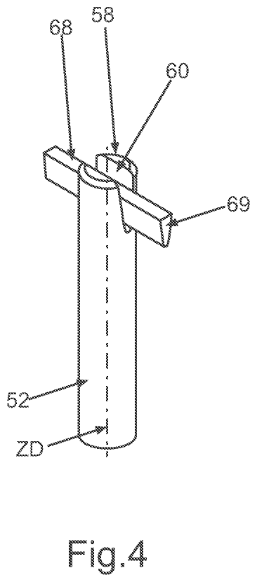

FIG. 4 shows a schematic representation of the other embodiment of the journal element 52 of FIG. 3. The axial end 58 of the journal element can have a stepped configuration. By an asymmetry in the bore of the threaded section 84, the alignment of blade or vane 51 and connecting device 50 can be clearly established. For example, a lug or a profile can be arranged on the axial end 58 of the journal element, corresponding to a shape or a profile of the bore of the threaded section 84.

The features disclosed in FIG. 3 and FIG. 4 as well as the accompanying figure descriptions form an embodiment which already in itself can be considered to be an independent invention.

Due to the aspects of the invention, many problems which may occur in connecting devices of the prior art can be solved. Positioning elements 68 of the prior art may undergo stress during installation. For example, this may happen when tightening the nut 86. An alignment of the journal element 52 to the lever element 54 by the positioning element 68 can be achieved in the prior art with limited precision, due to large tolerances in the first seats 60 and/or second seats 66, which may not be sufficient under certain conditions. Connecting devices 50 of the prior art can be mounted on the blade or vane 51 with a twisting of 180°. Because the positioning element 68 in the prior art is situated above the contact surface 80 and the lever element 54, an increased radial design space is required.

A verification after the fact as to whether positioning elements 68 have been installed is not possible in the prior art.

1. A connecting device for an adjustable blade or vane of
a gas turbine, comprising:
a journal element connected to a respective blade or vane;
a lever element connected to the journal element, wherein the lever element and the journal element are jointly movable about a journal axis of rotation;
wherein a clamping element is provided, being situated relative to the lever element and the journal element, such that a force-locking connection is produced between the journal element, the clamping element, and the lever element;
the lever element, the clamping element, and the journal element are aligned relative to each other by a positioning element, the positioning element being received in a first seat of the journal element and a corresponding second seat of the lever element,
wherein the first seat is configured as a groove in the radially outer casing surface of the journal element and the second seat is configured as a groove in a radially inner contact surface of the lever element and the first seat and second seat together form a pocket-like or sleeve-like coupling section, in which the positioning element is received.

2. The connecting device according to claim 1, wherein the coupling section and the journal element are arranged concentrically to each other.

3. The connecting device according to claim 1, wherein the clamping element comprises a threaded section, on which a nut is fastened, the threaded section being arranged on an axial section of the clamping element facing away from the journal element, wherein a driving profile is introduced into a bore of the threaded section, the driving profile being configured to enable the clamping element to be held firmly during the mounting process.

4. The connecting device according to claim 3, wherein the driving profile is configured as an inner toothing.

5. The connecting device according to claim 3, wherein the driving profile is configured as a polygon.

6. The connecting device according to claim 1, wherein the journal element comprises multiple first seats, and
the lever element comprises multiple second seats in which respective positioning elements are situated.

7. The connecting device according to claim 6, wherein the first seats and the second seats make identical angles with each other.

8. The connecting device according to claim 6, wherein the first seats and the second seats make different angles with each other.

9. The connecting device according to claim 1, wherein the first seat of the journal element is situated at an axial height of the contact surface of the journal element.

10. The connecting device according to claim 1, wherein the lever element has an opening which runs from the groove to an outer wall of the lever element.

11. The connecting device according to claim 1, wherein a positioning element cross section of the positioning element has the shape of a trapezium and/or a triangle at least in regions along a longitudinal direction of the positioning element.

12. The connecting device according to claim 1, wherein the positioning element is received by the first seat and the second seat such that the positioning element is situated with a longitudinal direction offset from the center of the journal element.

13. The connecting device according to claim 1, wherein the journal element has a step or profile at one axial end of the journal element, which corresponds to a profile of a bore of the threaded section, to establish a clear alignment of the journal element in the clamping element.

14. An aircraft gas turbine, having multiple adjustable blades or guide vanes arranged alongside each other in the circumferential direction wherein a connecting device according to claim 1 is arranged at each blade or guide vane.
